(19) United States
(12) Patent Application Publication
(10) Pub. No.: US 2025/0253113 A1
(43) Pub. Date: Aug. 7, 2025

(54) AUTOMATIC OPENING MECHANISM

(71) Applicant: Chint Low Voltage Electrical Technology Co., Ltd., Songjiang District, Shanghai (CN)

(72) Inventors: Zhe GU, Songjiang District, Shanghai (CN); Weijun GE, Songjiang District, Shanghai (CN); Jiapeng JIANG, Songjiang District, Shanghai (CN)

(21) Appl. No.: 18/856,584

(22) PCT Filed: Sep. 6, 2023
(86) PCT No.: PCT/CN2023/117152

§ 371 Date: Oct. 11, 2024

(30) Foreign Application Priority Data
Sep. 7, 2022 (CN) 202211089451.8

(51) Int. Cl. H01H 71/10; H01H 3/30; H01H 3/32; H01H 3/34; H01H 71/24

(52) U.S. Cl. CPC H01H 71/1009; H01H 3/34; H01H 71/24; H01H 3/3031; H01H 2003/326

(57) ABSTRACT

An automatic opening mechanism that includes a turntable and a first energy turntable to rotate from an energy storage spring, a reset mechanism that includes a reset gear, and a tripping mechanism that includes a tripping unit. The first energy storage spring releases energy and drives the turntable to rotate from an energy storage position to an every release position; meanwhile, the operating shaft is driven to rotate from a closing position to an opening position. The operating shaft rotates from the opening position to the closing position and drives the turntable to rotate from the energy release position to the energy storage position so as to drive the first energy storage spring to store energy, and the turntable is engaged with the reset gear to drive the turntable to rate, and the reset gear drives the tripping unit to reset.

### TECHNICAL FIELD

The present invention relates to the field of low-voltage electrical appliances, and more particularly, to an automatic opening mechanism.

### BACKGROUND

A rotary disconnecting switch generally consists of an operating device and a switch body which are in driving connection with each other, wherein the switch body includes a plurality of switch units which are stacked together and synchronously closed or disconnected under the drive of the operating device. With the wide application of rotary disconnecting switches, new functional requirements are put forward for the rotary disconnecting switches. That is, when a system line has a fault, the rotary disconnecting switch has a remote tripping function, and may be manually closed when the fault is cleared, while the remote tripping function does not affect manual closing and opening operations of the disconnecting switch.

The operating device generally consists of an operating shaft, a delayed energy storage mechanism, a real-time energy storage mechanism, a locking mechanism, a tripping mechanism and a reset mechanism, wherein the operating shaft rotates between an opening position and a closing position to complete the opening and closing operations through the real-time energy storage mechanism; the operating shaft drives the delayed energy storage mechanism to be switched from an energy release state to an energy storage state and be in locking fit with the locking mechanism to maintain the energy storage state; the tripping mechanism drives the locking mechanism to actuate to release the locking fit from the delayed energy storage mechanism; the delayed energy storage mechanism releases energy and completes an opening operation through the real-time energy storage mechanism; and the reset mechanism is used to drive the tripping mechanism to reset after the operating device is tripped and opened.

The existing rotary disconnecting switch often has the following problems.
1. The tripping mechanism includes a magnetic flux trip, and after the tripping mechanism actuates, the magnetic flux trip is still energized, affecting the service life of the magnetic flux trip.
2. The reset mechanism is often implemented by a locking fastener of the locking mechanism, but the locking fastener has low strength and is easy to be damaged, affecting the reliable operation of the reset mechanism.
3. The existing reset mechanism typically requires manual operation to reset after a remote opening operation, as it does not automatically reset and necessitates manual intervention for resetting.

### SUMMARY

An object of the present invention is to overcome the defects of the prior art and provide an automatic operating mechanism, which can achieve a remote opening operation and automatic resetting of a tripping mechanism.

In order to achieve the above object, the present invention adopts the following technical solutions:

An automatic opening mechanism, comprising an operating shaft arranged rotatably around its own axis, a delayed energy storage mechanism, a reset mechanism and a tripping mechanism, wherein the delayed energy storage mechanism comprises a turntable and a first energy storage spring; the reset mechanism comprises a reset gear; the tripping mechanism comprises a tripping unit; and
the tripping unit triggers the delayed energy storage mechanism that is in an energy storage state; the first energy storage spring releases energy and drives the turntable to rotate from an energy storage position to an energy release position, so that the delayed energy storage mechanism is switched to an energy release state; meanwhile, the operating shaft is driven to rotate from a closing position to an opening position; the operating shaft rotates from the opening position to the closing position and drives the turntable to rotate from the energy release position to the energy storage position so as to drive the first energy storage spring to store energy, so that the delayed energy storage mechanism is switched from the energy release state to the energy storage state, and meanwhile, the turntable is engaged with the reset gear to drive the reset gear to rotate, and the reset gear drives the tripping unit to reset.

Preferably, the turntable rotates from the energy storage position toward the energy release position and drives the operating shaft to rotate from the closing position toward the opening position so as to output an opening operation force.

Preferably, after the turntable drives the tripping unit to reset through the reset gear, the turntable continues to rotate toward the energy storage position and is disengaged from the reset gear, and the reset gear automatically resets.

Preferably, the reset mechanism further comprises a gear reset elastic member, and the gear reset elastic member exerts an acting force to the reset gear, such that the reset gear resets.

Preferably, the gear reset elastic member is a tension spring or a torsion spring.

Preferably, the turntable comprises a turntable mainboard that is in driving fit with the operating shaft, and a turntable tooth part arranged on a circumferential side of the turntable mainboard; the reset gear comprises a gear tooth part that is used for being engaged with the turntable tooth part; and the turntable tooth part and the reset gear are sector-shaped gears.

Preferably, when the delayed energy storage mechanism is in the energy release state. the turntable tooth part is engaged with the reset gear.

Preferably, the tripping unit comprises a tripping unit ejector rod assembly and a tripping unit coil assembly, and the reset gear is in driving fit with the tripping unit ejector rod assembly.

Preferably, the reset gear comprises a gear driving part; the reset gear is driven by the turntable to rotate, so as to press the tripping unit ejector rod assembly through the gear driving part, such that the tripping unit ejector rod assembly resets.

Preferably, the gear driving part comprises a gear driving surface, the gear driving surface is an inclined plane, and the reset gear rotates so as to reset the tripping unit ejector rod assembly by pressing it through the gear driving surface.

Preferably, the tripping unit ejector rod assembly comprises a reset inclined plane that cooperates with the gear driving surface.

Preferably, the tripping unit ejector rod assembly comprises a tripping unit ejector rod and a tripping unit driving arm; the tripping unit driving arm comprises a driving arm mounting part, a driving arm connecting part and a driving arm driving part that are connected in sequence in a bending manner; and the reset inclined surface is arranged at a junction between the driving arm mounting part and the driving arm connecting part.

Preferably, the driving arm mounting part, the driving arm connecting part and the driving arm driving part form a Z-shaped structure as a whole; a plane where the driving arm mounting part is located is parallel to a plane where the driving arm driving part is located, the driving arm driving part is offset to a side where the tripping unit coil assembly is located, relative to the driving arm mounting part; and an extension direction of the driving arm connecting part is parallel to a moving direction of the tripping unit ejector rod assembly.

Preferably, a rotation axis of the reset gear is parallel to a moving direction of the tripping unit ejector rod assembly, and the gear driving surface of the reset gear is a spiral surface that extends in an axial direction of the reset gear.

Preferably, the reset gear comprises a gear body, a gear driving part and a gear tooth part; the gear driving part and the gear tooth part are both distributed on a circumferential side of the gear tooth body; the gear driving part is provided with the gear driving surface; the gear driving surface is a spiral surface that extends in a axial direction of the reset gear; and the gear tooth part is driven by an external force, such that the reset gear rotates.

Preferably, the reset gear further comprises a reset gear spring column; the reset gear spring column is arranged on the gear driving part; an axis of the reset gear spring column is parallel to the rotation axis of the reset gear; and the gear reset elastic member of the reset mechanism is a tension spring, wherein one end of the tension spring is fixed, while another end of the tension spring is connected to the reset gear spring column.

Preferably, when the delayed energy storage mechanism, the operating shaft rotates freely between the opening position and the closing position.

Preferably, the turntable is driven by the operating shaft to rotate from the energy release position to the energy storage position and is locked, so that the delayed energy storage mechanism is kept in the energy storage state; when the operating shaft is in the closing position and the delayed energy storage mechanism is in the energy storage state, there is an opening idle stroke between the turntable and the operating shaft; and the operating shaft is driven by an external force to rotate from the closing position to the opening position, and passes by the idle stroke relative to the turntable simultaneously.

Preferably, the turntable is coaxial with the operating shaft; the turntable comprises a turntable mainboard; the turntable mainboard is provided with a turntable shaft hole and at least one turntable driven hole; the turntable rotatably sleeves on the operating shaft through the turntable shaft hole; the turntable driven hole comprises a first surface and a second surface;
the operating shaft comprises a driving finger, wherein the driving finger is arranged in the turntable driven hole;
the driving finger presses against the first surface, such that the turntable rotates toward the energy storage position; and
when the operating shaft is in the closing position, there is an opening idle stroke between the second surface and the driving finger; and when the delayed energy storage mechanism releases energy, the first energy storage spring drives the turntable to rotate, and the first surface cooperates with the driving finger to drive the driving operating shaft to rotate toward the opening position.

Preferably, the turntable driven hole is a sector-shaped hole concentric with the turntable shaft hole, the turntable includes two sector-shaped holes, which are symmetrically formed in two radial sides of the turntable shaft hole. The delayed energy storage mechanism further includes a driving key. The driving key is inserted onto the operating shaft in a radial direction, and two ends of the driving key respectively protrude out of the two radial sides of the operating shaft as driving fingers, and are respectively arranged in the two sector-shaped holes.

Preferably, the tripping unit is a magnetic flux trip.

The automatic opening mechanism of the present invention realizes the remote opening operation in the cooperation of its delayed energy storage mechanism and tripping mechanism, and the turntable of the delayed energy storage mechanism cooperates with the reset gear of the reset mechanism to realize automatic resetting of a tripping unit of the tripping mechanism.

In addition, the delayed energy storage mechanism does not affect the manual opening and closing operations of the operating shaft.

### BRIEF DESCRIPTION OF THE DRAWINGS

FIG. 1 is a schematic structural diagram of a rotary disconnecting switch of the present invention;

FIG. 2 is a schematic structural diagram of the rotary disconnecting switch of the present invention, in which an operating device and a switch body are split;

FIG. 3 is a schematic diagram of projections of a delayed energy storage mechanism, a locking mechanism, a tripping mechanism and a reset mechanism in the present invention, in which the delayed energy storage mechanism is in an energy release state;

FIG. 4 is a schematic diagram of the delayed energy storage mechanism, the locking mechanism, the tripping mechanism and the reset mechanism in the present invention, in which the delayed energy storage mechanism is in a process of switching from an energy release state to the energy storage state;

FIG. 5 is a schematic diagram of projections of the delayed energy storage mechanism, the locking mechanism, the tripping mechanism and the reset mechanism in the present invention, in which the delayed energy storage mechanism is in the energy storage state, the turntable and the locking fastener are in a locked state, and the turntable is disengaged from the reset gear;

FIG. 6 is a schematic structural diagram of the delayed energy storage mechanism and the locking fastener in the present invention, in which the delayed energy storage mechanism is in the energy storage state, and the turntable and the locking fastener are in a locked state;

FIG. 7 is a schematic structural diagram of the delayed energy storage mechanism, the reset mechanism and the tripping mechanism in the present invention, in which the tripping unit of the tripping mechanism has been reset;

FIG. 8 is a schematic structural diagram of the delayed energy storage mechanism, the reset mechanism and the tripping mechanism in the present invention, in which the tripping unit of the tripping mechanism has not been reset;

FIG. 9 is a schematic diagram of an exploded structure of the delayed energy storage mechanism in the present invention;

FIG. 10 is a schematic structural diagram of a gasket in the present invention;

FIG. 11 is a schematic structural diagram of a turntable in the present invention;

FIG. 12 is a schematic structural diagram of a first bushing in the present invention;

FIG. 13 is a schematic sectional view of a device housing in the present invention;

FIG. 14 is a schematic exploded view of the device housing in the present invention;

FIG. 15 is a schematic structural diagram of an upper housing cover in the present invention;

FIG. 16 is a schematic structural diagram of a housing partition plate in the present invention;

FIG. 17 is a schematic structural diagram of a reset gear in the present invention;

FIG. 18 is a schematic structural diagram of a tripping unit in the present invention; and

FIG. 19 is a circuit topology diagram of the tripping mechanism in the present invention.

Reference symbols represent the following components:
s1—first space; s2—second space; p-partition plate; 101—housing base; 102—housing partition plate; 1021—gasket mounting groove; 1023—partition plate shaft hole; 1024—housing partition plate spring column; 1025—housing partition plate spring limiting groove; 1026—turntable stopper; 1027—partition plate jack; 103—upper housing cover; 1031—upper cover shaft hole; 104—housing panel; 1131—operating shaft; 121—gasket; 1211—gasket avoidance hole; 1212—gasket counterbore; 1213—gasket jack; 1214—first gasket clamping groove; 1215—second gasket clamping groove; 1216—gasket opening; 122—locking fastener; 1222—locking fastener mainboard; 1221—locking fastener driven part; 1223—locking fastener locking part; 123—locking fastener reset elastic member; 124—first bushing; 1241—first bushing body; 1242—first bushing head; 1245—sliding protrusion; 126—first energy storage spring; 1261—first spring fixed end; 1262—first spring driven end; 127—turntable; 1270—turntable mainboard; 1271—turntable shaft hole; 1273-74—turntable locking arm; 1273—turntable locking arm cooperation surface; 1274—turntable locking arm latching surface; 1275-77—turntable cooperation arm; 1275—turntable cooperation arm cooperation side edge; 1277—turntable cooperation arm limiting side edge; 1276—turntable driven hole; 12761—first surface; 12762—second surface; 1272—turntable tooth part; 128—driving key; 132—reset gear; 1320—gear body; 1321—gear driving part; 1321-0—gear driving surface; 1322—gear tooth part; 1323—reset gear spring column; 133—gear reset elastic member; 134—tripping unit; 1342—trip coil assembly; 1341—trip ejector rod assembly; 13410—trip driving arm; 13410-1—driving arm mounting part; 13410-2—driving arm connecting part; 13410-3—driving arm driving part; 1341—reset inclined plane; 13411—trip ejector rod; 1343—trip terminal; 135—circuit board; 136—signal interface; 137—transfer switch; 138—power supply terminal; 3—screw rod; and 4—handle.

### DETAILED DESCRIPTION OF THE INVENTION

The specific implementations of a disconnecting switch of the present invention will be further described below in conjunction with the embodiments given in the accompanying drawings of the specification. The disconnecting switch of the present invention is not limited to the description of the following embodiments.

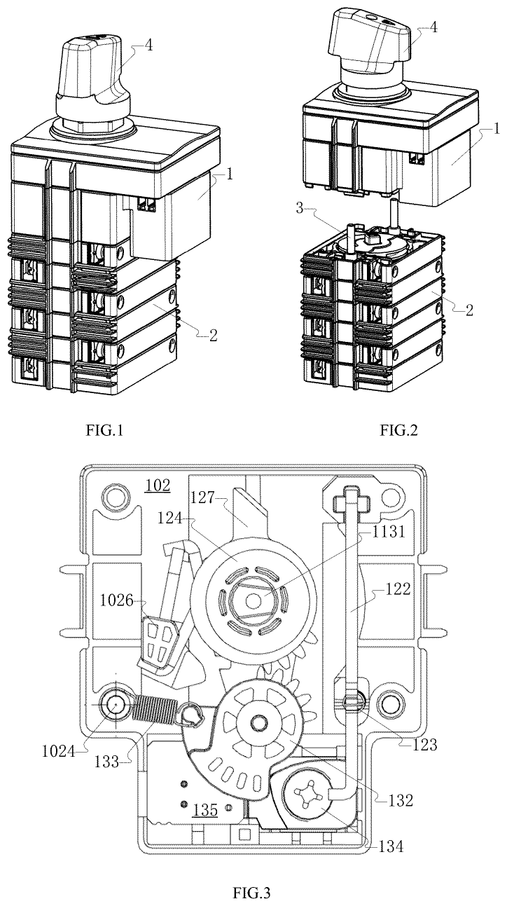

As shown in FIGS. 1-2, the present invention discloses a rotary disconnecting switch, preferably a remote-controlled rotary switch, which includes an operating device 1 and a switch body 2 that are in driving connection with each other, wherein the operating device 1 drives the switch body 2 to be connected or disconnected. Further, the operating device 1 is fixedly connected to the switch body 2 through a connector. Further, as shown in FIGS. 2 and 14, the connector is preferably a bolt. The bolt includes a screw rod 3 and a nut, wherein the screw rod 3 passes through the switch body 2, and is then in threaded connection with the nut fixed on the operating device 1 (the nut is preferably arranged on a housing base 101 of a device housing of the operating device). Of course, it is not excluded that the operating device 1 and the switch body 2 are connected in other ways, e.g., by means of a rivet or a buckle.

As shown in FIGS. 1-3. the switch body 2 includes at least one switching unit. The switching unit includes a moving contact assembly that is rotatably arranged and a static contact that cooperates with the moving contact assembly. The operating device 1 is in driving connection with the moving contact assembly of the switching unit, and drives the moving contact assembly to rotate to connect or disconnect with the static contact, such that the circuit is connected or disconnected. Further, the switch body 2 includes a plurality of switching units arranged in a laminated manner, and the moving contact assemblies of the respective switching units are arranged rotatably in linkage.

As shown in FIGS. 4-12, the operating device 1 includes an operating shaft 1131 arranged rotatably around its own axis, a delayed energy storage mechanism, a real-time energy storage mechanism, a locking mechanism, a tripping mechanism and a reset mechanism. The operating shaft 1131 rotates between an opening position and a closing position to output an opening and closing operation force to the real-time energy storage mechanism. The real-time energy storage mechanism includes a second energy storage spring. The operating shaft 1131 is in transmission fit with the real-time energy storage mechanism. and is used for driving the second energy storage spring to first store energy and then release energy, so that the operating device 1 is driven to be quickly switched between an opened state and a closed state, and the operating device 1 drives the switch body 2 to be connected to or disconnected from the circuit quickly. When the operating shaft 1131 rotates from the closing position to the opening position, the operating device 1 is driven by the real-time energy storage mechanism to be switched to the opened state; and when the operating shaft 1131 is switched from the opening position to the closing position, the operating device 1 is driven by the real-time energy storage mechanism to be switched to the closed state. The delayed energy storage mechanism includes a first energy storage spring 126. The delayed energy storage mechanism has an energy storage state with the first energy storage spring 126 completing energy storage and an energy release state with the first energy storage spring 126 completing energy release. The locking mechanism is used for locking the delayed energy storage mechanism in the energy storage state. The tripping mechanism is used for triggering the locking mechanism to release locking fit from the delayed energy storage mechanism, so that the delayed energy storage mechanism releases energy, and is switched from the energy storage state to the energy release state. in order to drive the operating device 1 to be switched from the closed state to the opened state. When the operating shaft 1131 rotates from the opening position to the closing position, the delayed energy storage mechanism is driven to be switched from the energy release state to the energy storage state. and the delayed energy storage mechanism is in locking fit with the locking mechanism, such that the delayed energy storage mechanism is locked in the energy storage state. When the delayed energy storage mechanism is locked in the energy storage state by the locking mechanism, it avoids the operating shaft 1131, that is, the operating shaft 1131 rotates between the closing position and the opening position at this moment without affecting the state of the delayed energy storage mechanism. When the operating device 1 is in a tripped and opened state, that is, the tripping mechanism triggers the delayed energy storage mechanism to release energy and the operating device 1 is driven by the delayed energy storage mechanism to be opened, the operating shaft 1131 rotates from the opening position to the closing position, driving the first energy storage spring 126 of the delayed energy storage mechanism to store energy, and meanwhile driving the tripping mechanism to reset through the reset mechanism, so as to prepare for the next tripping and opening operations. That is, the operating device 1 is in the opened state and the delayed energy storage mechanism is in the energy release state, and the operating shaft 1131 rotates from the opening position to the closing position, driving the operating device 1 to be switched to the closed state through the real-time energy storage mechanism, and meanwhile driving the delayed energy storage mechanism to be switched to the energy storage state, and the delayed energy storage mechanism is in locking fit with the locking mechanism to keep in the energy storage state. When the delayed energy storage mechanism is in the energy storage state, the operating shaft 1131 is freely switched between the closing position and the opening position. That is, when the operating device 1 is in the opened state and the delayed energy storage mechanism is in the energy release state, the operating shaft 1131 rotates from the opening position to the closing position, driving the operating device 1 to be switched to the closed state through the real-time energy storage mechanism, and meanwhile driving the delayed energy storage mechanism to be switched to the energy storage state, and the delayed energy storage mechanism is in locking fit with the locking mechanism to keep in the energy storage state. When the delayed energy storage mechanism is in the energy storage state, the operating shaft 1131 is freely switched between the closing position and the opening position. That is, an external force can be directly exerted to the operating shaft 1131, such that the operating shaft is driven to rotate between the opening position and the closing position, in order to drive the operating device 1 to be switched freely between the opened state and the closed state, without affecting the state of the energy storage mechanism. When the operating device 1 is in the closed state and the delayed energy storage mechanism is in the energy storage state, after the tripping mechanism receives a tripping signal, the locking mechanism is driven to release from locking fit the delayed energy storage mechanism, and the delayed energy storage mechanism releases energy and drives the operating device 1 to be switched to the opened state. The operating shaft 1131 rotates in two opposite directions to rotate between opening position and closing position. Therefore, the operating device 1 can be opened in two ways. One way is to screw the operating shaft 1131 with an external force to drive the operating device 1 to be opened manually. The other way is to input a tripping signal to the tripping mechanism through a remote control mode. The tripping mechanism actuates to trigger the delayed energy storage mechanism to release energy, and the delayed energy storage mechanism drives the operating device 1 to be opened, thereby realizing remote opening control for the rotary disconnecting switch. After the tripping mechanism actuates to trigger the delayed energy storage mechanism to release energy and drive the operating device 1 to be opened, the operating shaft 1131 drives the operating device 1 to be closed again, and meanwhile drives the delayed energy storage mechanism to be switched to the energy storage state. The delayed energy storage mechanism drives the tripping mechanism to reset through the reset mechanism at the same time. Further, the locking mechanism includes a locking fastener 122. The locking fastener 122 is used for being in locking fit with the time-delayed energy storage mechanism, such that the delayed energy storage mechanism is locked in the energy storage state. The tripping mechanism includes a tripping unit 134 which is used for driving the locking fastener 122 to actuate, such that the locking fastener 122 releases locking fit from the delayed energy storage mechanism. After the delayed energy storage mechanism is switched to the energy storage state, it is in locking fit with the locking fastener 122 to keep in the energy storage state. After the tripping mechanism receives the tripping signal, the tripping unit 134 actuates to drive the locking fastener 122 to release locking fit from the delayed energy storage mechanism. The resetting of the tripping mechanism also refers to the resetting of the tripping unit 134.

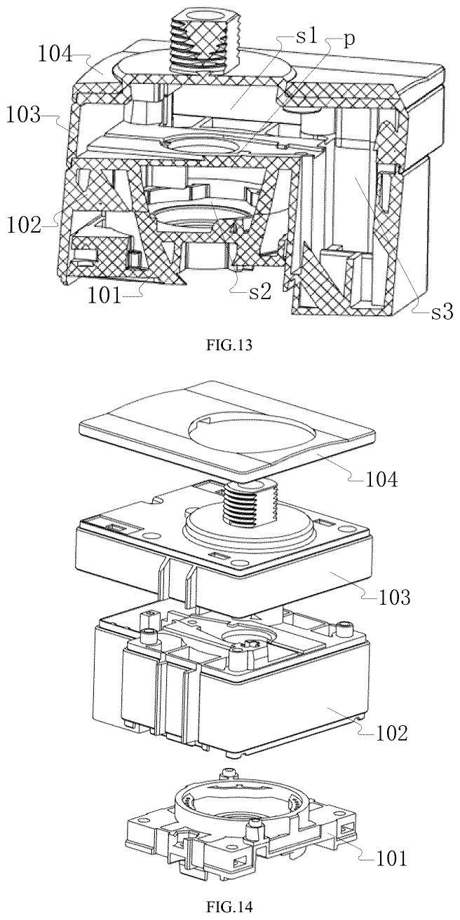

As shown in FIGS. 1-9, and 13-16, the operating device 1 also includes a device housing, and the time-delayed energy storage mechanism, the real-time energy storage mechanism, the locking mechanism and a tripping mechanism are all arranged in the device housing. Further, as shown in FIG. 13, the device housing includes a first space s1 and a second space s2 which are arranged in an axial direction of the operating shaft 1131. A partition plate p is arranged between the first space s1 and the second space s2. The time-delayed energy storage mechanism is arranged in the first space s1. The real-time energy storage mechanism is arranged in the second space s2. The partition plate p is provided with a partition plate shaft hole 1023 for the operating shaft 1131 to pass through. The operating shaft 1131 is rotatably inserted into the first space s1 and the second space s2 and cooperates respectively with the time-delayed energy storage mechanism and the real-time energy storage mechanism. One end of the operating shaft 1131 protrudes out of the device housing for operation, and the other end of the operating shaft 1131 is inserted into the second space s2 after passing through the first space s1 and the partition plate p sequentially. Further, as shown in FIGS. 13-14. the device housing includes an upper housing cover 103, a housing partition plate 102 and a housing base 101 that cooperate with each other sequentially. The upper housing cover 103 and the housing partition plate 102 are buckled to enclose the first space s1. The housing partition plate 102 and the housing base 101 are buckled to enclose the second space s2. The housing partition plate 102 includes a partition plate p.

Preferably, as shown in FIGS. 13-14, the device housing further includes a housing panel 104. The housing panel 104 and the housing partition plate 102 are respectively located at two sides of the upper housing cover 103. The housing panel 104 is fixedly connected to the upper housing cover 103. Further, a panel clamping foot is arranged on one side of the housing panel 104 facing the upper housing cover 103. An upper cover camping hole is formed in one side of the upper housing cover 103 facing the housing panel 104. The panel clamping foot is clamped in the upper cover clamping hole.

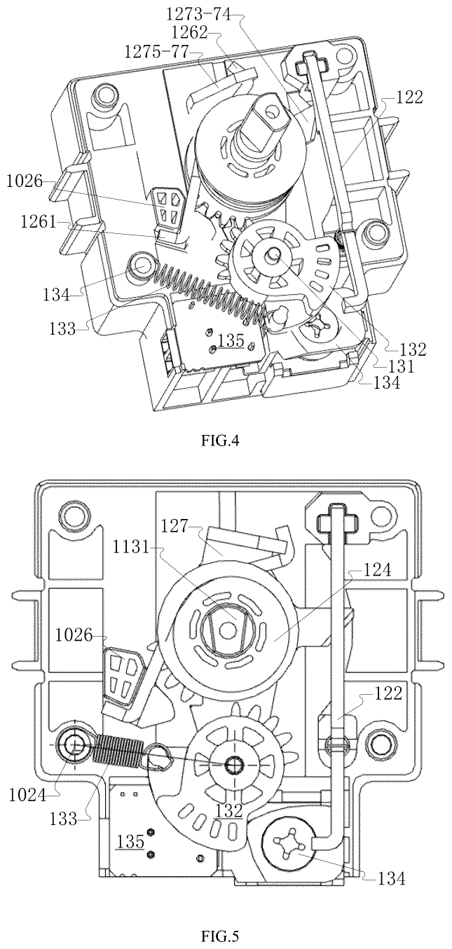

As shown in FIGS. 3-9, and 13-14, the locking mechanism is preferably arranged in the first space s1.

Preferably, as shown in FIG. 13, the device housing further includes a third space s3 for accommodating the tripping mechanism. The third space s3 and the second space s2 are arranged side by side in a radial direction of the operating shaft 1131. Further, the third space s3 is arranged on the housing partition plate 102.

As shown in FIG. 15, the upper housing cover 103 includes an upper cover shaft column. An upper cover shaft hole 1031 is formed in the middle of the upper cover shaft column. The operating shaft 1131 is rotatably inserted into the upper cover shaft hole 1031.

The real-time energy storage mechanism can be implemented through the prior art. For example, when the operating shaft 1131 rotates between the closing position and the opening position to complete the closing and opening operations through the real-time energy storage mechanism, the real-time energy storage mechanism undergoes a process of energy storage first and then energy release. When the real-time energy storage mechanism stores energy, the switch body 2 preferably does not actuate; and when the real-time energy storage mechanism releases energy, the switch body 2 is driven to be switched between the closed state and a broken state. Specifically, the real-time energy storage mechanism includes a second energy storage spring and an output shaft; the energy storage and energy release processes of the real-time energy storage mechanism are the energy storage and energy release processes of the second energy storage spring; when the second energy storage spring stores energy, the output shaft does not rotate; and when the second energy storage spring releases energy, the output shaft is driven to rotate, and the output shaft drives the switch body 2 to be closed or disconnected.

As shown in FIGS. 4-12, as an embodiment of the time-delayed energy storage mechanism, the time-delayed energy storage mechanism is used for providing energy to the opening operation of the operating device, that is, the time-delayed energy storage mechanism provides the operating shaft 1131 with a driving force that drives the operating shaft to rotate from the closing position to the opening position. Specifically, the delayed energy storage mechanism includes a first energy storage spring 126; when the operating shaft 1131 rotates from the opening position to the closing position to drive the operating device to be closed, the first energy storage spring 126 is driven to store energy, that is, the delayed energy storage mechanism is driven to be switched from the energy release state to the energy storage state; and in the course of remote opening control, the delayed energy storage mechanism releases energy, that is, the first energy storage spring 126 releases energy. and provides the operating shaft 1131 with a driving force for driving the operating shaft 1131 to rotate from the closing position to the opening position.

When the operating device 1 is in the closed state, the delayed energy storage mechanism releases energy to drive the operating shaft 1131 to rotate, and then the operating shaft 1131 drives the operating device 1 to be switched to the opened state through the real-time energy storage mechanism. Compared with the delayed energy storage mechanism of the prior art which directly drives the opening operation through the real-time energy storage mechanism, the overall structure of the operating device is simplified, and the working stability and reliability are improved. The rotary disconnecting switch in this embodiment, whether manually operated or remotely controlled, needs to output an opening or closing operation force through the operating shaft 1131, and completes the opening operation or closing operation through the real-time energy storage mechanism.

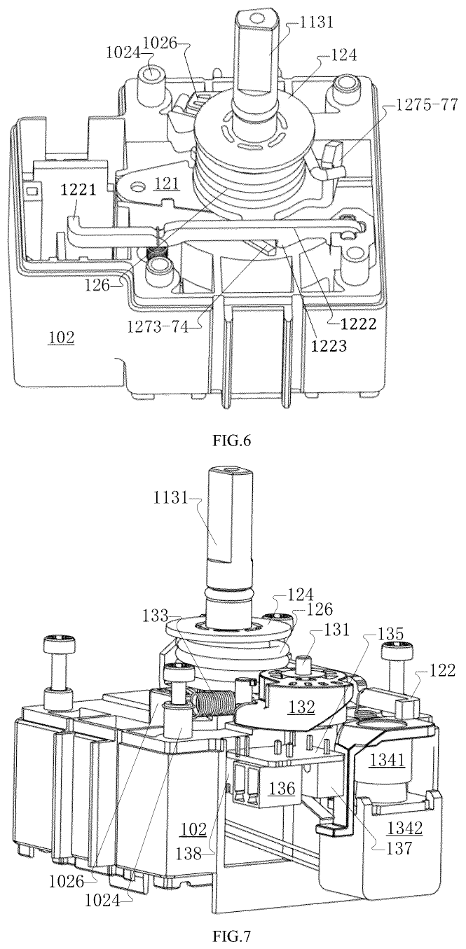

As shown in FIGS. 4, and 6-9, the time-delayed energy storage mechanism includes a turntable 127 and a first energy storage spring 126. The turntable 127 is driven by the operating shaft 1131 to rotate from the energy release position to the energy storage position. such that the first energy storage spring 126 stores energy. In addition, when the turntable 127 is locked in the energy storage position, the delayed energy storage mechanism is kept in the energy storage state. When the operating shaft 1131 is in the closing position, that is, the operating device 1 is in the closed state, there is an opening idle stroke between the turntable 127 and the operating shaft 1131. When the operating shaft 1131 is driven by an external force to rotate, the operating shaft 1131 rotates from the closing position to the opening position, such that the operating device 1 is switched to the opened state, and the operating shaft 1131 passes by the opening idle stroke relative to the turntable 127 simultaneously. Further, as shown in FIGS. 5-6, the turntable 127 is in locking fit with the locking fastener 122 of the locking mechanism, the turntable 127 is locked at the energy storage position, and the turntable 127 cooperates directly with the locking fastener 122, which is conducive to improving the stability and reliability of the cooperation between the delayed energy storage mechanism and the locking mechanism.

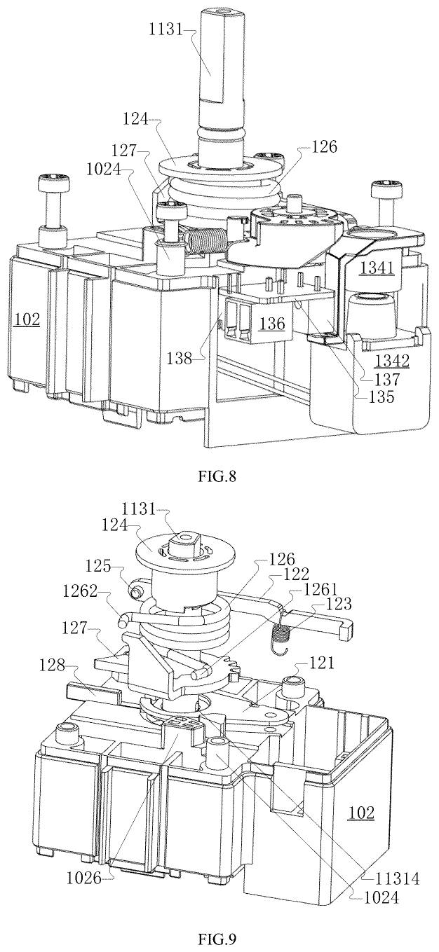

As shown in FIGS. 9 and 11, the turntable 127 is coaxial with the operating shaft 1131. The turntable 127 includes a turntable mainboard 1270. The turntable mainboard 1270 is provided with a turntable shaft hole 1271 and at least one turntable driven hole 1276. The turntable 127 rotatably sleeves the operating shaft 1131 through the turntable shaft hole 1271. The turntable driven hole 1276 includes a first surface 12761 and a second surface 12762. The delayed energy storage mechanism includes a driving finger which is fixedly arranged on the operating shaft 1131 and rotates in synchronization with the operating shaft, and the driving finger is arranged in the turntable driven hole 1276. The driving finger presses against the first surface 12761, such that the turntable 127 rotates toward the energy storage position. When the operating shaft 1131 is in the closing position, there is an opening idle stroke between the second surface 12762 and the driving finger. At this moment, the operating shaft 1131 rotates from the closing position to the opening position, and the operating shaft 1131 drives the driving finger to pass by the opening idle stroke relative to the turntable 127. Meanwhile, a closing idle stroke is formed between the driving finger and the first surface 12761. At this moment, the operating shaft 1131 rotates from the opening position to the closing position, and the operating shaft 1131 drives the driving finger to pass by the closing idle stroke relative to the turntable 127. An opening idle stroke is formed again between the driving finger and the second surface 12762. That is, when the delayed energy storage mechanism is in the energy storage state (the turntable 127 is located at the energy storage position), the operating shaft 1131 can rotate freely between the closing position and the opening position relative to the turntable 127, without affecting the state of the delayed energy storage mechanism. That is, the delayed energy storage mechanism will remain in the energy storage state. When the delayed energy storage mechanism releases energy, the first energy storage spring 126 releases energy to drive the turntable 127 to rotate toward the energy release position. the first surface 12761 cooperates with the driving finger, and the operation shaft 1131 is driven to rotate toward the opening position. The operating shaft 1131 preferably drives the operating device 1 to be switched to the opened state through the real-time energy storage mechanism.

As shown in FIG. 11, the turntable driven hole 1276 is a sector-shaped hole concentric with the turntable shaft hole 1271, and the first surface 12761 and the second surface 12672 are respectively arranged at two ends of the sector-shaped hole in a circumferential direction. Further, the turntable 127 includes two sector-shaped holes, which are symmetrically formed in two radial sides of the turntable shaft hole 1271. The delayed energy storage mechanism further includes a driving key 128. The driving key 128 is inserted onto the operating shaft 1131 in a radial direction, and two ends of the driving key 128 respectively protrude out of the two radial sides of the operating shaft 1131 as driving fingers, and are respectively arranged in the two sector-shaped holes. Further, radial inner ends of the two sector-shaped holes are communicated with the turntable shaft hole 1271 respectively, three of which are integrally formed into a dumbbell-shaped structure. As shown in FIG. 9. the operating shaft 1131 is provided with an operating shaft jack 11314 for a driving member 128 to be inserted.

As another embodiment, the opening idle stroke between the turntable 127 and the operating shaft 1131 can also be implemented in the following ways. Specifically, the operating shaft 1131 is provided with a sector-shaped groove, a circle center of the sector-shaped groove coincides with an axis of the operating shaft 1131. and two ends of the sector-shaped groove in a circumferential direction are two driving surfaces, which are a first driving surface and a second driving surface respectively; the turntable 127 includes a turntable driven finger arranged in the turntable shaft hole 1271, and the turntable driven finger is inserted in the sector-shaped groove; when the operating shaft 1131 rotates from the opening position to the closing position, the first driving surface presses against the turntable driven finger, such that the turntable 127 rotates from the energy release position to the energy storage position, and the turntable 127 is locked at the energy storage position. There is an opening idle stroke between the second driving surface and the turntable driven finger, and at this moment, when the operating shaft 1131 rotates from the closing position to the opening position, the operating shaft 1131 passes by the opening idle stroke relative to the turntable 127. There is a closing idle stroke between the second driving surface and the turntable driven finger, and at this moment, when the operating shaft 1131 rotates from the opening position to the closing position, the operating shaft 1131 passes by the closing idle stroke relative to the turntable driven finger. That is, when the delayed energy storage mechanism is in the energy storage state (the turntable 127 is located at the energy storage position), the operating shaft 1131 can freely rotate between the closing position and the opening position to drive the operating device to be switched between the closed state and the opened state.

As shown in FIGS. 6-9, the first energy storage spring 126 is a torsion spring that rotatably sleeves the operating shaft 1131. The first energy storage spring 126, the turntable 127 and the operating shaft 1131 are coaxially arranged. Two ends of the first energy storage spring 126 are respectively a first spring fixed end 1261 that is fixedly arranged and a first spring driven end 1262 that cooperates with the turntable 127. The turntable 127 rotates toward the energy storage position and drives the first spring driven end 1262 to swing, such that the first energy storage spring 126 twists and stores energy.

As another embodiment. the first energy storage spring 126 is a linear compression spring. wherein one end of the first energy storage spring is rotatably arranged on the housing partition plate 102 of the device housing, and the other end of the first energy storage spring is rotatably connected to the turntable 127. The turntable 127 rotates from the energy release position toward the energy storage position, so that the first energy storage spring 126 is compressed for energy storage, and the energy storage position of the turntable 127 is in front of a dead center position of the first energy storage spring 126. The dead center position of the first energy storage spring 126 refers to a position of the first energy storage spring 126 when a geometric axis of the first energy storage spring 126 is located in the same straight line with the axis of the turntable 127. Of course, the first energy storage spring 126 may also be replaced with a torsion spring, and two ends of the torsion spring are respectively rotatably connected to the housing partition plate 102 and the turntable 127. At this time, the dead center position of the first energy storage spring 126 refers to a position of the first energy storage spring 126 when two ends of the torsion spring are located on the same straight line with the turntable 127. The above implementation mode will increase an occupied space of the delayed energy storage mechanism, so the torsion spring that rotatably sleeves the operating shaft 1131 is preferably adopted as the first energy storage spring 126 of the present embodiment.

As shown in FIGS. 3-6, the turntable 127 includes a turntable mainboard 1270 and a turntable cooperation arm 1275-77. One end of the first spring fixed end 1261 of the first energy storage spring 126 is fixed on the device housing. The first spring driven end 1262 cooperates with the turntable cooperation arm 1275-77. The turntable 127 pushes the first spring driven end 1262 to swing through the turntable cooperation arm 1275-77, such that the first energy storage spring 126 twists and stores energy. Further, the turntable 127 is rotatably arranged on the housing partition plate 102 of the device housing. The housing partition plate 102 is provided with a turntable stopper 1026 and a housing partition plate spring limiting groove 1025. The first spring fixed end 1261 is fixed in the housing partition plate spring limiting groove 1025. The turntable stopper 1026 is in limiting fit with the turntable cooperation arm 1275-77. such that the turntable 127 is limited at the energy release position. Further, the housing partition plate spring limiting groove 1025 is formed on the turntable stopper 1026. The turntable cooperation arm 1275-77 includes a turntable cooperation arm limiting side edge 1277 and a turntable cooperation arm cooperation side edge 1275 which are arranged oppositely. The turntable cooperation arm limiting side edge 1277 cooperates with the turntable stopper 1026. The turntable cooperation arm cooperation side edge 1275 cooperates with the first spring driven end 1262.

Preferably, as shown in FIG. 11, the turntable cooperation arm 1275-77 is connected with the turntable mainboard 1270 in a bending manner. Further, the turntable cooperation arm 1275-77 is perpendicular to the turntable 1270.

As shown in FIGS. 3-9, the delayed energy storage mechanism further includes a first bushing 124. The first bushing 124 rotatably sleeves on the operating shaft 1131 and is inserted between the first energy storage spring 126 and the operating shaft 1131, which can prevent the first energy storage spring 126 from locking the operating shaft 1131 while twisting for energy storage, ensure the reliable and stable work of the delayed energy storage mechanism, correct a direction of the first energy storage spring 126, and weaken a torsional moment effect of the first energy storage spring 126 on the operating shaft 1131.

As shown in FIGS. 6, 9 and 10, the delayed energy storage mechanism further includes a gasket 121 arranged on the housing partition plate 102 of the device housing. As shown in FIG. 12. the first bushing 124 includes a first bushing head 1242 and a first bushing body 1241 which are coaxially arranged and connected to each other. The first bushing head 1242 has an outer diameter greater than an outer diameter of the first bushing body 1241 and greater than an outer diameter of a first spring spiral body of the first energy storage spring 126. The first bushing body 1241 is inserted between the first spring spiral body and the operating shaft 1131. The gasket 121 is arranged on the housing partition plate 102. The first energy storage spring 126, the turntable 127 and the gasket 121 are sequentially arranged between the upper housing cover 103 and the housing partition plate 102. The first bushing head 1242 cooperates with the upper housing cover 103 to limit the first bushing 124 from moving in an axial direction of the operating shaft 1131. The first spring spiral body is located between the first bushing head 1242 and the turntable 127. The turntable 127 is rotatably arranged on the gasket 121. The gasket 121 forms protection for the housing partition plate 102, so as to avoid the turntable 127 from rotating and wearing the housing partition plate 102, which is conducive to prolonging the service life. Further, one end of the first bushing body 1241 is connected to the first bushing head 1242, a plurality of sliding protrusions 1245 is arranged at the other end of the first bushing body 1241, and the sliding protrusions 1245 abut against the turntable 127, which is conducive to reducing a sliding resistance between the first bushing 124 and the turntable 127. In addition, the sliding protrusions 1245 can also carry out plane limiting on a warping tendency generated by the turntable 127 under the effect of an eccentric torque of the first energy storage spring 126. The plurality of sliding protrusions 1245 is preferably evenly distributed on a free end of the first bushing body 1241 in a circumferential direction of the first bushing body 1241.

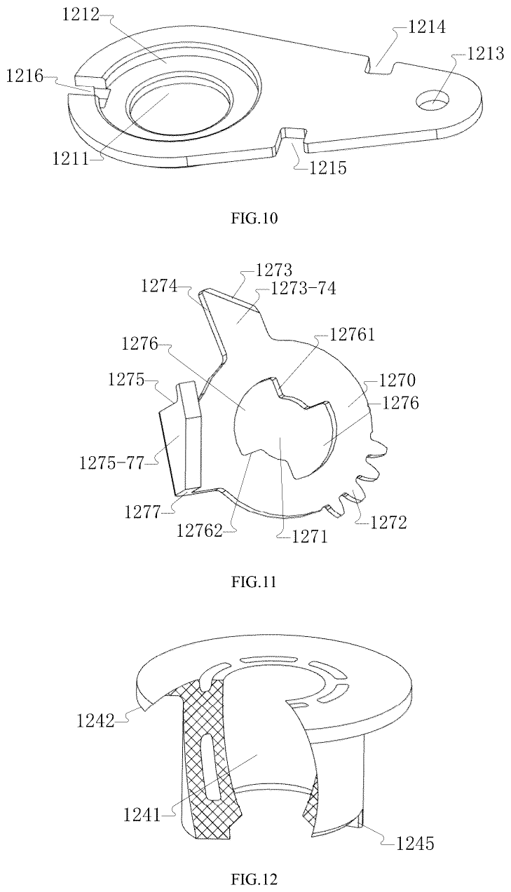

As shown in FIGS. 9-10, the gasket 121 is provided with a gasket avoidance hole 1211 for the operating shaft 1131 to pass through, a gasket counterbore 1212 formed in one side of the gasket 121 facing the turntable 127, and a gasket opening 1216 for the driving key 128 of the delayed energy storage mechanism to pass through. The gasket counterbore 1212 has an internal diameter greater than an inner diameter of the gasket avoidance hole 1211 and less than an outer diameter of the turntable mainboard 1270 of the turntable 127. The gasket opening 1216 is communicated with the gasket counterbore 1212. The driving key 128 enters the gasket counterbore 1212 through the gasket opening 1216, is inserted onto the operating shaft 1131, and swings in the gasket counterbore 1212. When the operating device is assembled, the operating shaft 1131 is assembled together with the real-time energy storage mechanism at first, the delayed energy storage mechanism is then assembled, and the gasket opening 1216 is convenient for the assembly of the driving key 128 and the operating shaft 1131, so the assembly efficiency is improved. Further, the gasket 121 further includes a first gasket clamping groove 1214 and a second gasket clamping groove 1215. The two gasket clamping grooves are respectively formed in two opposite sides of the gasket 121, and are respectively in clamping fit with the housing partition plate 102 of the device housing.

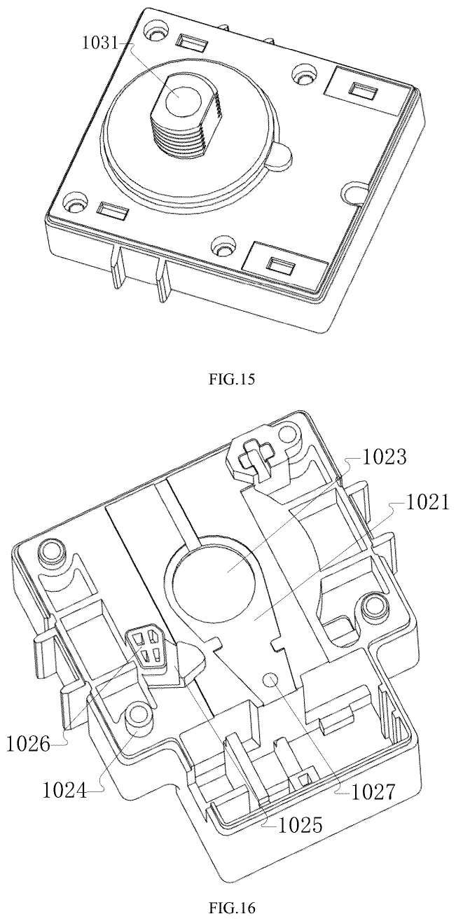

As shown in FIG. 16, the housing partition plate 102 is provided with a gasket mounting groove 1021. A bottom wall of the gasket mounting groove 1021 is provided with a partition plate shaft hole 1023 for the operating shaft 1131 to pass through. Two partition plate clamping platforms, i.e., a first partition plate clamping platform and a second partition plate clamping platform, that cooperate with the first gasket clamping groove 1214 and the second gasket clamping groove 1215 are arranged in the gasket mounting groove 1021 respectively.

As shown in FIGS. 3-7, and 9, as an embodiment of the locking mechanis, the locking mechanism can be implemented in many ways. The core function of the locking mechanism is to be in locking fit with the delayed energy storage mechanism, such that the delayed energy storage mechanism is locked in the energy storage state.

As shown in FIGS. 3-6, and 9, the locking fastener 122 of the locking mechanism is rotatably arranged, and includes a locking fastener mainboard 1222 and a locking fastener locking part 1223. The turntable 127 further includes a turntable locking arm 1273-74 arranged on the turntable mainboard 1270. In the process of rotating the turntable 127 from the energy release position to the energy storage position (that is, a process that the turntable 127 drives the first energy storage spring 126 to store energy), the turntable locking arm 1273-74 presses against the locking fastener locking part 1223, such that the locking fastener 122 rotates in an unlocking direction to avoid the turntable locking arm 1273-74. After the turntable locking arm 1273-74 crosses over the locking fastener locking part 1223, the locking fastener 122 rotates in a locking direction to reset and is in limiting fit with the turntable locking arm 1273-74, and the turntable 127 is limited in the energy storage position, so that the delayed energy storage mechanism is kept in the energy storage state. The unlocking direction and the locking direction are opposite directions to each other. The locking fastener 122 rotates to a first direction (the unlocking direction) to avoid the turntable locking arm 1273-74, so that the turntable locking arm 1273-74 and the locking fastener locking part 1223 are unlocked, and the first energy storage spring 126 releases energy to drive the turntable 127 to rotate from the energy storage position to the energy release position. Further, the locking fastener locking part 1223 is arranged on a side edge of the locking fastener mainboard 1222 facing the turntable 127.

As shown in FIGS. 3-7, a rotating plane of the locking fastener 122 is perpendicular to a rotating plane of the turntable 127. Of course, the rotating plane of the locking fastener 122 may also be parallel to the turntable 127, and a structural form of the locking fastener locking part 1223 and a cooperation mode of the turntable locking arm 1273-74 and the locking fastener locking part 1223 also need to be adjusted accordingly.

As shown in FIGS. 3-6, and 9, one end of the locking fastener 122 is a locking fastener pivoting end, and a locking fastener driven part 1221 is arranged at the other end of the locking fastener 122. The locking fastener 122 is rotatably arranged through the locking fastener pivoting end. The locking fastener 122 is driven by an external force (e.g., the tripping unit 134 of the tripping mechanism) through the locking fastener driven part 1221 to rotate in the first direction, so that the locking fastener locking part 1223 releases locking fit from the turntable locking arm 1273-74. Further, the locking fastener driven part 1221 is connected with the locking fastener mainboard 1222 in a bending manner, and a plane where the locking fastener driven part 1221 is located intersects with a plane where the locking fastener mainboard 1222 is located. Further, the plane where the locking fastener driven part 1221 is perpendicular to the plane where the locking fastener mainboard 1222 is located. and one end of the locking fastener mainboard 1222 which connected to the locking fastener driven part 1221 is flush with a side edge of the locking fastener driven part 1221.

As shown in FIGS. 3-6, and 9, the locking fastener pivoting end is provided with a locking fastener shaft hole. The locking mechanism further includes a locking fastener shaft 125 fixed on the housing partition plate 102 of the device housing. The locking fastener 122 is rotatably arranged on the locking fastener shaft 125 through the locking fastener shaft hole.

Preferably, as shown in FIG. 6, the locking fastener locking part 1223 includes a locking part guiding surface and a locking part locking surface, wherein the turntable locking arm 1273-74 presses against the locking part guiding surface, such that the locking fastener 122 rotates in an unlocking direction, and the turntable locking arm 1273-74 is in limiting fit with the locking part locking surface, such that the turntable 127 is locked at the energy storage position. Further, the locking fastener locking part 1223 is coplanar with the locking fastener mainboard 122. The locking fastener locking part 1223 is arranged on a side edge of the locking fastener mainboard 1222 facing the turntable mainboard 1270. The locking fastener locking part 1223 is of a wedge-shaped structure, and has a large-diameter end connected to the locking fastener mainboard 1222, and a tip end facing the turntable mainboard 1270.

Preferably, as shown in FIG. 6, the locking fastener guiding surface is an inclined plane, and this inclined plane is inclined from one end close to the locking fastener pivoting end in a direction away from the locking fastener mainboard 1222.

As another embodiment, the locking fastener locking part 1223 is not provided with a locking part guiding surface; the turntable locking arm 1273-74 is provided with a locking arm guiding surface; and when the turntable 127 rotates from the energy release position toward the energy storage position, the locking arm guiding surface presses against a free end of the locking fastener locking part 1223, so that the locking fastener 122 rotates in an unlocking direction to avoid the turntable locking arm 1273-74.

As shown in FIGS. 3. 5 and 11, the turntable locking arm 1273-74 includes a turntable locking arm cooperation surface 1273, a turntable locking arm latching surface 1274 and a turntable locking arm structural surface. The turntable locking arm cooperation surface 1273 cooperates with the locking part guiding surface of the locking fastener locking part 1223 to drive the locking fastener 122 to rotate in an unlocking direction. The turntable locking arm latching surface 1274 is in limiting fit with the locking arm latching surface of the locking fastener locking part 1223. One end of the turntable locking arm 1273-74 is connected to the turntable mainboard 1270, and the turntable locking arm cooperation surface 1273 is arranged at the other end of the turntable locking arm 1273-74. The turntable locking arm latching surface 1274 is opposite to the turntable locking arm structural surface. Two ends of the turntable locking arm latching surface 1274 and two ends of the turntable locking arm structural surface are respectively connected to the turntable locking arm cooperation surface 1273 and the turntable mainboard 1270. Further, the turntable locking arm latching surface 1274 is parallel with the turntable locking arm structural surface. An included angle between the turntable locking arm latching surface 1274 and the locking arm cooperation surface 1273 is less than 90°, and an included angle between the turntable locking arm structural surface and the locking arm cooperation surface 1273 is greater than 90°.

As shown in FIGS. 3-6, and 9, the locking mechanism further includes a locking fastener reset elastic member 123, which exerts an acting force to the locking fastener 122, such that the locking fastener 122 rotates in a locking direction to reset.

As shown in FIG. 9, the locking fastener reset elastic member 123 is a tension spring, wherein one end of the tension spring is connected to the housing partition plate 102 of the device housing, and the other end of the tension spring is connected to the locking fastener 122. Further, the locking fastener 122 further includes a mainboard limiting groove formed on the locking fastener mainboard 1222, wherein one end of the tension spring is arranged in the mainboard limiting groove; and the mainboard limiting groove and the locking fastener locking part 1223 are respectively arranged on a pair of opposite side edges of the locking fastener mainboard 1222.

As another embodiment, the locking fastener reset elastic member 123 may also be a torsion spring, the torsion spring sleeves on a rotating shaft of the locking fastener 122, and one end of the tension spring is fixed on the housing partition plate 102, the other end of the tension spring cooperates with the locking fastener mainboard 1222.

As shown in FIGS. 3-5, 7-8, and 18-19, as an embodiment of the tripping mechanism, the tripping mechanism is used for driving the locking mechanism to release from the locking fit with the delayed energy storage mechanism, so that the delayed energy storage mechanism releases energy, the driving operating shaft 1131 rotates to output an opening operation force, and the opening operation is preferably implemented through the real-time energy storage mechanism.

As shown in FIGS. 7-8. and 18, the tripping unit 134 of the tripping mechanism includes a tripping unit coil assembly 1342 and a tripping unit ejector rod assembly 1341 that are used cooperatively. After the tripping unit 134 receives a tripping signal, the tripping unit ejector rod assembly 1341 actuates to drive the locking fastener 122 to rotate in an unlocking direction, such that the locking fastener 122 releases from the locking fit with the delayed energy storage mechanism, and the delayed energy storage mechanism releases energy to drive the operating shaft 1131 to rotate from the closing position toward the opening position and outputs an opening operation force. Further, the tripping unit ejector rod assembly 1341 is in transmission fit with the locking fastener driven part 1221 of the locking fastener 122. As shown in FIGS. 7-8, and 18, the tripping unit 134 is preferably a magnetic flux trip. As other embodiments, the tripping unit 134 may also be a shunt trip device or a relay. etc.

As shown in FIGS. 7-8, the tripping mechanism further includes a transfer switch 137 that is connected in series in the power supply circuit of the tripping unit 134. After the tripping mechanism receives the tripping signal to actuate, the tripping unit 134 drives the transfer switch 137 to actuate to cut off the power supply circuit of the tripping device 134, so as to avoid an electromagnetic coil of the tripping unit 134 being energized for a long time and being damaged.

As shown in FIGS. 7-8, the transfer switch 137 is a micro switch, which includes a driving rod that cooperates with the tripping unit 134. Further, as shown in FIG. 19, the transfer switch 137 includes a switch moving contact, a normally open contact NO and a normally closed contact NC. A first input terminal of a tripping unit coil of the tripping unit 134 is electrically connected to the normally open contact NO, a second input terminal of the tripping unit coil of the tripping unit 134 is electrically connected to one phase of an external circuit, and the normally closed contact NO is vacant (that is, the normally closed contact NO is not electrically connected to a circuit structure other than itself). The switch moving contact is electrically connected to the other phase of the external circuit, that is, the switch moving contact and the second input terminal of the tripping unit coil are electrically connected to the external circuit through the circuit board 135 and the signal interface 135. When the tripping unit 134 actuates, the tripping unit ejector rod assembly 1341 ejects and drives the switch moving contact to actuate, such that the switch moving contact is disconnected from the normally open contact NO and is closed with the normally closed contact NC.

As shown in FIGS. 7-8, when the tripping unit 134 actuates, the tripping unit ejector rod assembly 1341 moves as a whole relative to the tripping unit coil assembly 1342 to drive the locking fastener 122 to release from the locking fit with the delayed energy storage mechanism, and meanwhile drives the transfer switch 137 to actuate to cut off the power supply circuit of the tripping unit 134.

As shown in FIGS. 7-8, and 18, the tripping unit ejector rod assembly 1341 includes a tripping unit ejector rod 13411 and a tripping unit driving arm 13410, wherein one end of the tripping unit ejector rod 13411 is movably inserted in the tripping unit coil assembly 1342 and the other end of the tripping unit ejector rod 13411 is fixedly connected to the tripping unit driving arm 13410. The tripping unit driving arm 13410 includes a driving arm mounting part 13410-1 that is fixedly connected to the tripping unit ejector rod 13411 and is used for outputting a first driving force, and a driving arm driving part 13410-3 for outputting a second driving force. The first driving force is used for driving the locking fastener 122 to actuate. such that the locking fastener 122 is released from the locking fit with the delayed energy storage mechanism (that is, the driving arm mounting part 13410-1 is in transmission fit with the locking fastener 122 to drive the locking fastener to rotate in an unlocking direction). The second driving force is used for driving the transfer switch 137 to actuate to cut off the power supply circuit of the tripping unit 134 (that is, the driving arm driving part 13410-3 is in triggering fit with the transfer switch 137 to trigger the transfer switch 137 to switch an on/off state). Further, the driving arm mounting part 13410-1 and the driving arm driving part 13410-3 are distributed in a stepped type. that is. the driving arm mounting part 13410-1 and the driving arm driving part 13410-3 are located at step surfaces of the adjacent two steps. The driving arm driving part 13410-3 is offset to a side where the tripping unit coil assembly 1342 is located, relative to the driving arm mounting part 13410-1.

As shown in FIG. 18. the driving arm mounting part 13410-1 includes a mounting part driving surface for outputting the first driving force. The driving arm driving part 13410-3 includes a driving part driving surface for outputting the second driving force. The mounting part driving surface and the driving part driving surface are arranged in parallel and are both perpendicular to a moving direction of the tripping unit ejector rod 13411.

As shown in FIGS. 7-8, and 18, the tripping unit driving arm 13410 further includes a driving arm connecting part 13410-2, the driving arm mounting part 13410-1, the driving arm connecting part 13410-2 and the driving arm driving part 13410-3 are connected sequentially in a bending manner and form a Z-shaped structure as a whole. A plane where the driving arm mounting part 13410-1 is located is parallel to a plane where the driving arm driving part 13410-3 is located. Further, an extension direction of the driving arm connecting part 13410-2 is parallel to a moving direction of the tripping unit ejector rod 13411.

As shown in FIG. 18, the driving arm mounting part 13410-1 preferably includes a mounting part driving board and a mounting plate plug sleeve, wherein one side of the mounting part driving board is connected to one end of the mounting plate plug sleeve, and the mounting part plug sleeve is in plug-in connection with the tripping unit ejector rod 13411. achieving simple and reliable assembly.

As shown in FIGS. 7-8, and 18, the tripping unit driving arm 13410 is preferably an integrated injection molding structure.

The tripping unit coil assembly 1342 includes a tripping unit coil, a moving iron core. a static iron core, a tripping unit yoke and a tripping unit spring. The tripping unit ejector rod 13411 is inserted into one end in the tripping unit coil assembly 1342 and is fixedly connected to the moving iron core. The tripping unit spring exerts an acting force to the moving iron core to make it separate from the static iron core. The tripping unit coil is energized to generate a magnetic field, so that the moving iron core and the static iron core are attracted with each other, such that the tripping unit ejector rod 13411 is ejected.

As shown in FIGS. 7-8, the tripping mechanism further includes a circuit board assembly. The circuit board assembly includes a circuit board 135, and a power supply terminal 138, a signal interface 136 and a transfer switch 137 that are respectively arranged on the circuit board 135 and electrically connected to the circuit board 135. That is, the power supply terminal 138. the signal interface 136 and the transfer switch 137 are all arranged in a printed circuit of the circuit board 135 and are connected in series with each other. The transfer switch 137 is connected in series in the power supply circuit of the tripping unit 134. A wiring terminal of the tripping unit 134 is connected to the power supply terminal. The signal interface 136 is electrically connected to the external circuit for receiving a tripping signal.

As shown in FIGS. 7-8, the signal interface 136 is preferably a plug-in interface, which is convenient for quick connection with the external circuit, thereby improving the connection efficiency.

As shown in FIG. 18, the tripping unit 134 further includes a tripping unit terminal 1343 connected to the tripping unit coil of the tripping unit coil assembly 1342. and the tripping unit terminal 1343 is in plug-in connection with the power supply terminal 138.

As shown in FIGS. 7-8. the circuit board assembly is arranged on one side of the tripping unit 134. The power supply terminal 138, the signal interface 136 and the transfer switch 137 are arranged on the same side of the circuit board 135. The power supply terminal 138 and the signal interface 136 are located on one side of the transfer switch 137, while the tripping unit 134 is located at the other side of the transfer switch 137.

As shown in FIGS. 3-8, and 17, as an embodiment of the reset mechanism, the reset mechanism is used for driving the tripping mechanism to reset. Specifically, the delayed energy storage mechanism stores energy drives the tripping mechanism is driven to reset through the reset mechanism while storing energy, so as to prepare for the next action.

As shown in FIGS. 3-8, and 17, the reset mechanism includes a reset gear 132 that is arranged rotatably. After the operating device 1 of the present invention is tripped and opened (that is, the tripping unit 134 actuates to trigger the delayed energy storage mechanism to release energy, the delayed energy storage mechanism drives the operating device 1 to be opened. and meanwhile the operating shaft 1131 rotates from the closing position to the opening position), the operating shaft 1131 rotates from the opening position to the closing position, driving the operating device 1 to be closed, and meanwhile driving the turntable 127 to rotate from the energy release position to the energy storage position to drive the first energy storage spring 126 to store energy, so that the delayed energy storage mechanism is switched from the energy release state to the energy storage state. Meanwhile, the turntable 127 drives the reset gear 132 to rotate, and the return gear 132 drives the tripping unit 134 to reset, that is, the tripping unit ejector rod assembly 1341 that drives the tripping unit 134 resets.

As shown in FIGS. 4-5, the turntable 127 drives the tripping unit 134 to reset through the reset gear 132, then continues to rotate to the energy storage position and is disengaged from the reset gear 132, and the reset gear 132 automatically resets. That is to say, in the process of rotating from the energy release position to the energy storage position. the turntable 127 drives the tripping unit 134 to reset through the reset gear 132. After the tripping unit 134 has been reset, the turntable 127 continues to rotate toward the energy storage position. During this process, the turntable 127 is disengaged from the reset gear 132, and then the reset gear 132 automatically resets. Further, the reset mechanism further includes a gear reset elastic member 133, and the gear reset elastic member 133 exerts an acting force to the reset gear 132, such that the reset gear 132 resets.

As shown in FIGS. 7-8, a rotation axis of the reset gear 132 is parallel to a moving direction of the tripping unit ejector rod assembly 1341 of the tripping unit 134. As shown in FIG. 3, when the delayed energy storage mechanism is in the energy release state, the turntable 127 is at the energy release position and is engaged with the reset gear 132.

As shown in FIGS. 3-5, and 7-8, the gear reset elastic member 133 is a tension spring, wherein one end of the tension spring is connected to the reset gear 132, and the other end of the tension spring is connected fixedly. Further, a housing partition plate spring column 1024 is arranged on the shell partition plate 102, wherein one end of the gear reset elastic member 133 is connected to a part other than a rotation center of the reset gear 132, and the other end of the gear set elastic member is connected to the housing partition plate spring column 1024. Further, a reset gear spring column 1323 is arranged on the gear driving part 1321 of the reset gear 132, wherein one end of the gear reset elastic member 133 is connected to the reset gear spring column 1323, and the other end of the gear reset elastic member 133 is connected to the housing partition plate spring column 1024.

As another embodiment, the gear reset elastic member 133 is a torsion spring, which is coaxial with the rotating shaft of the reset gear 132, wherein one end of the tension spring is fixedly arranged on the housing partition plate 102, and the other end of the tension spring cooperates with the reset gear 132.

As shown in FIGS. 3-5, 11 and 17, the turntable 127 includes a turntable tooth part 1272 arranged on the turntable mainboard 1270 in a circumferential side. The reset gear 132 includes a gear tooth part 1322. The turntable tooth part 1272 is in engagement fit with the gear tooth part 1322. Further, the turntable tooth part 1272 and the gear tooth part 1322 are sector-shaped gears.

As shown in FIGS. 3-5, and 17, the reset gear 132 includes a gear driving part 1321. The reset gear 132 is driven by the turntable 127 to rotate. The tripping unit ejector rod assembly 1341 is pressed by the gear driving part 1321, such that the tripping unit ejector rod assembly 1341 resets. Further, the gear driving part 1321 includes a gear driving surface 1321-0. The gear driving surface 1321-0 is an inclined plane. The reset gear 132 rotates to resets the tripping unit ejector rod assembly 1314 by pressing against it through the gear driving surface 1321-0.

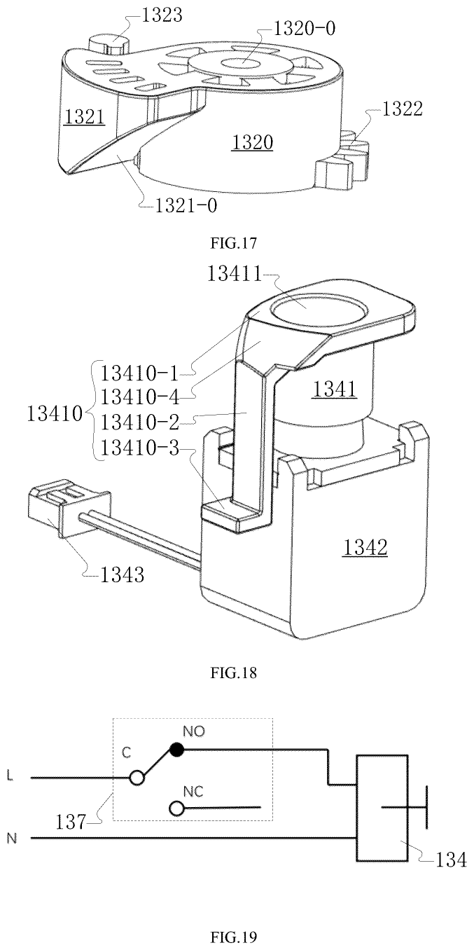

As shown in FIG. 17, a rotation axis of the reset gear 132 is parallel to a moving direction of the tripping unit ejector rod assembly 1341, and the gear driving surface 1321-0 is a spiral surface that extends in an axial direction of the reset gear 132. Further, the gear driving surface 1321-0 is a normal helicoid surface that extends in an axial direction of the reset gear 132.

As another embodiment, a rotation axis of the reset gear 132 is perpendicular to a moving direction of the tripping unit ejector rod assembly 1341, and the gear driving surface 1321-0 is in a shape of an involute on a cross-section of the reset gear 132.

As shown in FIGS. 3-5, 7-8, and 17, as an embodiment of the reset gear 132, the reset gear 132 includes a gear body 1320, a gear tooth part 1322. a gear driving part 1321 and a reset gear spring column 1323. A reset gear shaft hole 1320-0 is formed in the middle of the gear body 1320. The gear driving part 1321 and the gear tooth part 1322 are respectively arranged at two radial ends of the gear body 1320. The reset gear spring column 1323 is arranged on the gear driving part 1321. An extension direction of the reset gear spring column 1323 is parallel to the rotation axis of the reset gear 132.

As shown in FIG. 11, as an embodiment of the turntable 127, the turntable 127 includes a turntable mainboard 1270, a turntable cooperation arm 1275-77, a turntable locking arm 1273-74 and a turntable tooth part 1272. A turntable shaft hole 1271 and a turntable driven hole 1276 are formed in the middle of the turntable mainboard 1270. The turntable driven hole 1276 is a sector-shaped hole. Two turntable driven holes 1276 are formed in two radial sides of the turntable shaft hole 127, and a radial inner end of each turntable driven hole 1276 is communicated with the turntable shaft hole 1271. The turntable cooperation arm 1275-77. the turntable locking arm 1273-74 and the turntable tooth part 1277 are distributed in a circumferential edge of the turntable mainboard 1270. A plane where the turntable cooperation arm 1275-77 is located is perpendicular to a plane where the turntable mainboard 1270 is located. The turntable locking arm 1273-74 is coplanar with the turntable mainboard 1270. A pair of side edges of the turntable cooperation arm 1275-77 are respectively a turntable cooperation arm cooperation side edge 1275 and a turntable cooperation arm limiting side edge 1277. One end of the turntable locking arm 1273-74 is connected to the turntable mainboard 127. The turntable locking arm 1273-74 includes a turntable locking arm cooperation surface 1273, a turntable locking arm locking surface 1274 and a turntable locking arm structural surface. One end of the turntable locking arm 1273-74 is connected to the turntable mainboard 1270, and the other end of the turntable locking arm 1273-74 is provided with the turntable locking arm cooperation surface 1273. The turntable locking arm locking surface 1274 is opposite to the turntable locking arm structural surface. Two ends of the turntable locking arm locking surface 1274 and two ends of the turntable locking arm structural surface are respectively connected to the turntable locking arm cooperation surface 1273 and the turntable mainboard 1270. An included angle between the turntable locking arm locking surface 1274 and the locking arm cooperation surface 1273 is less than 90°, and an included angle between the turntable locking arm structural surface and the locking arm cooperation surface 1273 is greater than 90°.

As shown in FIGS. 7-8, and 18, the tripping unit ejector rod assembly 1341 includes a reset inclined plane 13410-4 that cooperates with the gear driving surface 1321-0. Further, the reset inclined plane 13410-4 is arranged at the junction between the driving arm mounting part 13410-1 and the driving arm connecting part 13410-2.

As another embodiment, the tripping unit ejector rod assembly 1341 may also not be provided with a reset inclined surface 13410-4, but a reset protrusion, wherein a free end of the reset protrusion has a hemispherical structure which presses against the gear driving surface 1321-0 of the reset gear 132.

As shown in FIGS. 3-5 and 7-8, the reset gear 132 is rotatably arranged on the housing partition plate 102 of the device housing through the reset gear shaft 131. Further. as shown in FIG. 6 and FIG. 10, the gasket 121 is provided with a gasket jack 1213. As shown in FIG. 16. a bottom wall of the gasket mounting groove 1021 of the housing partition plate 102 is provided with a partition plate jack 1027. The gasket jack 1213 is opposite to the partition plate jack 1027. The reset gear shaft 131 is inserted into the partition plate jack 1027 through the gasket jack 1213. The reset gear 132 is rotatably arranged on the gasket 121. so that the damage to be housing partition plate 102 by the rotation of the reset gear 132 is avoided. thereby prolonging its service life.

As shown in FIG. 10, as an embodiment of the gasket 121, the gasket 121 is a teardrop-shaped plate structure. A large-diameter end of the gasket 121 is provided with a gasket avoidance hole 1211, a gasket counterbore 1212 and a gasket opening 1216, wherein the gasket counterbore 1212 is coaxial with the gasket avoidance hole 1211, and an inner diameter of the gasket counterbore 1212 is greater than that of the gasket avoidance hole 1211. One end of the gasket opening 1216 is communicated with the gasket counterbore 1212. and the other end of the gasket opening 1216 is communicated with the outside. A small-diameter end of the gasket 121 is provided with a gasket jack 1213. A pair of side edges of the gasket 121 are respectively provided with a first gasket clamping groove 1214 and a second gasket clamping groove 1215, which are staggered and are located between the gasket counterbore 1212 and the gasket jack 1213.

It should be explained that. in the description of the present invention. the terms such as “up”, “down”, “left”, “right”, “inner” and “outer” indicating the directional or positional relations on the basis of the directional or positional relations shown in the drawings are only used for conveniently describing the present invention and simplifying the description, not indicate or imply that the referred devices or elements must have a specific orientation and be configured and operated in a specific direction; therefore, they cannot be construed as a limitation on the present invention.

We have made further detailed description of the present invention mentioned above in combination with specific preferred embodiments, but it is not deemed that the specific embodiments of the present invention is only limited to these descriptions. A person skilled in the art can also, without departing from the concept of the present invention, make several simple deductions or substitutions, which all be deemed to fall within the protection scope of the present invention.

1. An automatic opening mechanism, comprising an operating shaft arranged rotatably around its own axis, a delayed energy storage mechanism, a reset mechanism and a tripping mechanism, wherein the delayed energy storage mechanism comprises a turntable and a first energy storage spring; the reset mechanism comprises a reset gear; the tripping mechanism comprises a tripping unit; and
the tripping unit triggers the delayed energy storage mechanism that is in an energy storage state, the first energy storage spring releases energy and drives the turntable to rotate from an energy storage position to an energy release position, so that the delayed energy storage mechanism is switched to an energy release state; meanwhile, the operating shaft is driven to rotate from a closing position to an opening position; the operating shaft rotates from the opening position to the closing position and drives the turntable to rotate from the energy release position to the energy storage position so as to drive the first energy storage spring to store energy, so that the delayed energy storage mechanism is switched from the energy release state to the energy storage state, and meanwhile, the turntable is engaged with the reset gear to drive the reset gear to rotate, and the reset gear drives the tripping unit to reset.

2. The automatic opening mechanism according to claim 1, wherein the turntable rotates from the energy storage position toward the energy release position and drives the operating shaft to rotate from the closing position toward the opening position so as to output an opening operation force; and
when the delayed energy storage mechanism is in the energy storage state, the operating shaft rotates freely between the opening position and the closing position.

3. The automatic opening mechanism according to claim 1, wherein after the turntable drives the tripping unit to reset through the reset gear, the turntable continues to rotate toward the energy storage position and is disengaged from the reset gear, and the reset gear automatically resets.

4. The automatic opening mechanism according to claim 3, wherein the reset mechanism further comprises a gear reset elastic member, and the gear reset elastic member exerts an acting force to the reset gear, such that the reset gear resets; and
the turntable comprises a turntable mainboard that is in driving fit with the operating shaft, and a turntable tooth part arranged on a circumferential side of the turntable mainboard; the reset gear comprises a gear tooth part that is used for being engaged with the turntable tooth part; and the turntable tooth part and the reset gear are sector gears.

5. The automatic opening mechanism according to claim 3, wherein when the delayed energy storage mechanism is in the energy release state, the turntable tooth part is engaged with the reset gear.

6. The automatic opening mechanism according to claim 1, wherein the tripping unit comprises a tripping unit ejector rod assembly and a tripping unit coil assembly, and the reset gear is in driving fit with the tripping unit ejector rod assembly; and
the reset gear comprises a gear driving part; the reset gear is driven by the turntable to rotate, so as to press the tripping unit ejector rod assembly through the gear driving part, such that the tripping unit ejector rod assembly resets.

7. The automatic opening mechanism according to claim 6, wherein the gear driving part comprises a gear driving surface, the gear driving surface is an inclined plane, and the reset gear rotates so as to reset the tripping unit ejector rod assembly by pressing it through the gear driving surface.

8. The automatic opening mechanism according to claim 7, wherein the tripping unit ejector rod assembly comprises a reset inclined plane that cooperates with the gear driving surface.

9. The automatic opening mechanism according to claim 8, wherein the tripping unit ejector rod assembly comprises a tripping unit ejector rod and a tripping unit driving arm; the tripping unit driving arm comprises a driving arm mounting part, a driving arm connecting part and a driving arm driving part that are connected in sequence in a bending manner; and the reset inclined surface is arranged at a junction between the driving arm mounting part and the driving arm connecting part; and
the driving arm mounting part, the driving arm connecting part and the driving arm driving part form a Z-shaped structure as a whole; a plane where the driving arm mounting part is located is parallel to a plane where the driving arm driving part is located; the driving arm driving part is offset to a side where the tripping unit coil assembly is located, relative to the driving arm mounting part; and an extension direction of the driving arm connecting part is parallel to a moving direction of the tripping unit ejector rod assembly.

10. The automatic opening mechanism according to claim 7, wherein a rotation axis of the reset gear is parallel to a moving direction of the tripping unit ejector rod assembly, and the gear driving surface of the reset gear is a spiral surface that extends in an axial direction of the reset gear.

11. The automatic opening mechanism according to claim 1, wherein the reset gear comprises a gear body, a gear driving part and a gear tooth part; the gear driving part and the gear tooth part are both distributed on a circumferential side of the gear tooth body; the gear driving part is provided with the gear driving surface; the gear driving surface is a spiral surface that extends in a axial direction of the reset gear; and the gear tooth part is driven by an external force, such that the reset gear rotates; and
the reset gear further comprises a reset gear spring column; the reset gear spring column is arranged on the gear driving part; an axis of the reset gear spring column is parallel to the rotation axis of the reset gear; and the gear reset elastic member of the reset mechanism is a tension spring, wherein one end of the tension spring is fixed, while another end of the tension spring is connected to the reset gear spring column.

12. The automatic opening mechanism according to claim 2, wherein the turntable is driven by the operating shaft to rotate from the energy release position to the energy storage position and is locked, so that the delayed energy storage mechanism is kept in the energy storage state; when the operating shaft is in the closing position and the delayed energy storage mechanism is in the energy storage state, there is an opening idle stroke between the turntable and the operating shaft; and when the operating shaft is driven by an external force to rotate from the closing position to the opening position, and passes by the idle stroke relative to the turntable.

13. The automatic opening mechanism according to claim 2, wherein the turntable is coaxial with the operating shaft; the turntable comprises a turntable mainboard; the turntable mainboard is provided with a turntable shaft hole and at least one turntable driven hole; the turntable rotatably sleeves on the operating shaft through the turntable shaft hole; the turntable driven hole comprises a first surface and a second surface;
the operating shaft comprises a driving finger, wherein the driving finger is arranged in the turntable driven hole;
the driving finger presses against the first surface, such that the turntable rotates toward the energy storage position; and
when the operating shaft is in the closing position, there is an opening idle stroke between the second surface and the driving finger; and when the delayed energy storage mechanism releases energy, the first energy storage spring drives the turntable to rotate, and the first surface cooperates with the driving finger to drive the driving operating shaft to rotate toward the opening position.

14. The automatic opening mechanism according to claim 6, wherein the tripping mechanism comprises a circuit board assembly and a tripping unit; the circuit board assembly comprises a circuit board, and a power supply terminal, signal interface and a transfer switch that are respectively arranged on the circuit board and electrically connected to the circuit board; the transfer switch is connected in series in the power supply circuit of the tripping unit; a wiring terminal of the tripping unit is connected to the power supply terminal; the signal interface is electrically connected to an external circuit for receiving a tripping signal; and when the tripping unit releases, the tripping unit ejector rod assembly actuates to drive the transfer switch to cut off the power supply circuit of the tripping unit.

15. The automatic opening mechanism according to claim 14, wherein the tripping unit comprises a tripping unit terminal connected to a tripping unit coil of the tripping unit coil assembly, and the tripping unit terminal is in plug-in connection with the power supply terminal;
the signal interface is a plug-in interface; and
the power supply terminal, the signal interface and the transfer switch are arranged on one side of the circuit board, the power supply terminal and the signal interface are located on one side of the transfer switch, while the tripping unit is located at the other side of the transfer switch.
